(19) United States
(12) Patent Application Publication
(10) Pub. No.: US 2008/0086516 A1
(43) Pub. Date: Apr. 10, 2008

(54) Automatically changing a database system's redo transport mode to dynamically adapt to changing workload and network conditions

(75) Inventors: George H. Claborn, Amherst, NH (US); Mahersh B. Girkar, Cupertino, CA (US)

Correspondence Address: GORDON E. NELSON, PATENT ATTORNEY, PC, 57 CENTRAL STREET, P.O. BOX 782, ROWLEY, MA, 01969, US

(73) Assignee: Oracle International

(21) Appl. No.: 11/542,850

(22) Filed: Oct. 4, 2006

(51) Int. Cl. G06F 17/30

(52) U.S. Cl. 707/202

(57) ABSTRACT

Techniques for automatically changing the mode used in a primary database system to transport redo to a standby database system in response to changing workload and network conditions. The techniques are implemented in a database system that has a constraining redo transport mode that can potentially constrain the rate at which the primary database system can process transactions and a nonconstraining redo transport mode which does not constrain the primary but has a higher probability of redo loss than the constraining redo transport mode. The techniques use the constraining redo transport mode as a measuring transport mode to determine whether a switch from one mode to the other is desirable either to increase the throughput of the primary database system or to decrease the probability of the loss of redo data.

### CROSS-REFERENCE TO RELATED APPLICATIONS

Not applicable

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

The invention relates generally to database systems and more particularly to techniques for maintaining backup copies of databases.

2. Description of Related Art

### Using a Standby Database System to Maintain a Current Backup Copy: FIG. 1

One way of continuously maintaining a current backup copy of a database is by using two database systems, a primary database system, which contains the original of the database (the primary database), and a remotely located standby database system, which contains a current backup copy of the database (the standby database). Pairs of database systems that do this are shown in FIG. 1 As the primary database system performs transactions on a primary database 103, it generates redo data and saves it in a redo log (not shown). If something happens in the primary database system that requires a transaction to be redone, the primary database system can apply the redo data for the transaction to the primary database to redo the transaction. To maintain the standby database, the primary database system makes a copy 107 of the redo data as it is generated and sends the copy via network 105 to the remote standby database system 108 or 110, which archives the redo data in archived redo logs 109 and then applies the redo data (111 or 115, 117, 119) to standby database 113 or 121 and thereby keeps the standby database transactionally current with the primary database.

Standby systems 108 and 110 show two different techniques for applying redo data: in standby system 108, standby database 113 is an exact physical copy of primary database 103 and redo data 107 is applied to standby database 113 in the form in which it came from the primary database system. In standby system 110, standby database 121 is a logical copy of primary database 103, i.e., an SQL statement that is executed on primary database 103 and then on standby database 121 or vice-versa will have identical results. Because standby database 121 is a logical copy, the redo data in log 109(ii) must be translated into SQL statements, as shown at 115 and 117. After this is done, the redo data is applied to standby database 121 by executing the SQL statement on logical standby database 121.

The degree of protection which a standby database 113 or 121 affords against failure in a primary database 103 depends on the probability that a failure in the primary database system will result in the standby database system receiving less than all of the redo data generated by the primary database system. As long as the standby database system has received all of the redo data generated by the primary database system up to the time of the primary database system's failure, the standby database system can take over from the primary database system without loss of data. The probability of the standby database system receiving less than all of the redo data generated by the primary in turn depends on how closely the operation of standby database system 108 or 110 is coupled to the operation of the primary database system. In general, the closer the coupling, the lower the probability of the standby receiving less than all of the redo data generated by the primary.

The most closely coupled mode of operation is termed in the following synchronous transport of the redo data to the standby. In this mode of operation, the primary database system first writes a buffer full of redo data to its redo data log then sends a packet containing a copy of the redo data in the buffer to the standby database system. When the standby database system has written the redo data to its redo log 109, it sends a confirmation message to the primary, which then and only then returns control to the application that generated the redo. The standby database system's redo data log is thus guaranteed to have a copy of each packet of redo data whose transaction has been acknowledged by the primary database system to a redo-generating application.

The time it takes to send a packet of redo data is the time required to transfer the packet across the network plus the time it takes to write the packet to the standby database system's redo log plus the time required to transfer the confirmation message across the network. This time is termed in the following the packet's network I/O latency. When a synchronous transport is used to send redo data to the standby, the network I/O latency determines the maximum rate at which redo data may be sent to the standby database system. That in turn determines the maximum rate at which the primary database system can generate redo data, and that, finally, determines the maximum rate at which the primary database system can process transactions. Because this is so, use of a synchronous transport is said to constrain the rate at which the primary database system can process transactions. Moreover, if a failure in the standby database system or in the network prevents a confirmation from reaching the primary database system, the primary database system must cease producing redo and consequently must cease processing transactions. A primary database system in this condition is said to have stalled.

The primary and standby databases systems are more loosely coupled when an asynchronous transport is used for the redo data. An asynchronous transport neither constrains the rate at which the primary database system processes transactions nor does the primary database system stall if there is a failure in the standby database system or in the network. On the other hand, there is no guarantee that the standby database system will have a copy of every packet of redo data that the primary database system has generated for a transaction. In the asynchronous transport, the primary database system writes the redo data as before to its redo data log, but sending the redo data to the standby database is an independent operation. The operation is performed by a process which reads the primary database system's redo log and sends the new redo data it finds there to the standby database system. The process sends the redo data at whatever time and rate is convenient to it. Because writing the redo data to the primary's redo log and sending it to the standby are independent operations, the rate at which the primary database system can process transactions is not constrained by when the redo data is sent to the standby database system or the network I/O latency. On the other hand, because the primary's redo data is not written to the standby as it is produced, failure of the primary or of the network connection between the primary and the standby may leave the standby with an incomplete copy of the redo data.

As can be seen from the foregoing, there is a tradeoff between the probability of data loss and the speed at which the primary database system can process transactions. In database management systems produced by Oracle Corporation, of Redwood City, Calif., the administrator of the database management system has a limited ability to manage this tradeoff by specifying one of three protection modes:
maximum protection. In this mode, a synchronous transport is employed.
maximum performance. In this mode, an asynchronous transport is employed.
maximum availability. In this mode a synchronous transport is employed until the primary detects a failure of the standby or network. On detection, it ceases shipping redo to the standby and automatically switches to an asynchronous transport mode. The primary then periodically attempts to re-establish a connection to the standby. Once the connection is re-established, the primary uses an asynchronous transport mode until it is determined that the standby has caught up with the primary, i.e., received all of the redo data generated by the primary from the time of the standby's failure to the present, at which time the primary automatically switches back to a synchronous transport. Two parameters specified by the database administrator control the manner in which the primary perceives that the standby has failed and the manner in which the primary attempts to reconnect with the standby.
   a NET_TIMEOUT time period that must not be exceeded for the receipt of a confirmation when the synchronous transport is employed. When the next confirmation fails to arrive, the primary stalls until the confirmation arrives or the NET_TIMEOUT period has passed. When the latter occurs, the primary responds by declaring the standby destination to have failed and switching to an asynchronous transport mode, which ends the stall. No further redo is shipped to the standby until a connection to the standby has been successfully re-established.
   a REOPEN time period that indicates the minimum amount of time the primary will wait after the failure of the standby or after a previous attempt to reconnect before the primary again attempts reconnecting to a failed standby destination.

While maximum availability provides automatic recovery from the failure of the standby by automatically switching to an asynchronous transfer mode after the NET_TIMEOUT period, which ends the stall, by automatically reconnecting to the standby using the asynchronous transport mode when the standby is again available, and by automatically shifting to the synchronous transport mode when the standby has caught up to the primary, it still really only automates recovery from a failure of the standby. In particular, it does not solve the following problems:
1. Because the primary operates in the synchronous transfer mode except while the standby has failed and during recovery from the failure, the primary is for the most part subject to the constraints imposed by the synchronous transfer mode.
2. The constraints prevent the primary from fully utilizing a network's maximum capacity.
3. Maximum availability only shifts to the asynchronous mode on failure of the standby and only until the standby has caught up. It does not provide a mechanism for shifting between synchronous and asynchronous transport modes as workload conditions in the primary and in the network vary.
4. The Maximum Availability protection mode described above is very abrupt and severe in its transition from synchronized to unsynchronized:
   A) It doesn't make the transition until the network or standby is literally gone; that is until NETWORK_TIMEOUT seconds expires without acknowledgement from the standby.
   B) During this wait for acknowledgement or the end of the NETWORK_TIMEOUT period (typically, 10s of seconds), all applications on the primary are stalled.
   C) Even if NETWORK_TIMEOUT is reduced to a small value (say, 1 second) in order to at least attempt to account for network congestion, the destination is put in an error state when the synchronous link is broken.
   D) Once the synchronous link is broken, no redo is shipped to the standby for an extended period of time thus exposing the business to severe data loss in the event of disaster.
   E) Once the network/standby are available again, the primary can be slow in actually detecting their return and thus recommencing redo shipment.
   F) Once redo shipment has recommenced, the primary can be slow in detecting when the standby has caught up, and thus slow in transitioning the configuration back into a no-data-loss state.

It is an object of the present invention to provide techniques for automatically changing the transport method used by a primary database system which overcome the above problems of the maximum availability mode.

### BRIEF SUMMARY OF THE INVENTION

The object of the invention is attained by a method of automatically changing the redo transport mode in a database system that has a primary database system in which redo is produced and a standby database system to which the redo may be transported by a number of redo transport modes. The method has the steps of:
making a determination whether a current transport mode should be changed to another transport mode. The determination is made using a measuring redo transport mode.
if the determination indicates that the current transport mode should be changed, automatically switching to the other transport mode.

In the step of making a determination, a rate at which the primary database system is currently producing redo may be taken into account, a current condition of a network by which the redo is transported may be taken into account, or both may be taken into account. The current condition of the network is determined by determining a current network I/O latency for the measuring redo transport. In the step of making a determination, a sliding window is used to measure the rate at which the primary database system is currently producing redo and/or the current condition of the network.

In another aspect, the object of the invention is attained by a method of automatically changing the redo transport mode in a database system that has a primary database system in which the redo is produced and a standby database system to which the redo may be transported. The transport modes include a constraining redo transport mode that potentially constrains the rate at which the primary database system processes transactions and a nonconstraining redo transport mode that does not do so. The method makes a determination whether the constraining redo transport mode would constrain a current transaction processing rate of the primary database system. If the determination so indicates and the current redo transport mode is the constraining redo transport mode, the method automatically switches to the nonconstraining transport mode. If the determination does not so indicate and the current redo transport mode is the nonconstraining transport mode, the method switches to the constraining transport mode.

The constraining transport mode may have a lower probability of redo loss than the non-constraining transport mode.

In a further aspect, the object of the invention is attained by a database system that has a primary database system in which redo is produced and a standby database system to which the redo may be transported by a number of redo transport modes. The redo transport modes include a constraining redo transport mode that potentially constrains the rate at which the primary database system processes transactions but has a lower risk of loss of redo and a nonconstraining redo transport mode that does not constrain the rate at which the primary database system processes transactions but has a higher risk of loss of redo. The database system is characterized in that:

the database system includes user-settable state that permits a user to specify which redo transport mode is to be used in the database system, the user-settable state specifying in the alternative
that the database system operate only in the constraining redo transport mode,
that the database system operate only in the nonconstraining redo transport mode, and
that the database system
   operate in the constraining redo transport mode as long as the database system continues to determine that a current transaction processing rate at which the primary database system is currently processing transactions is not being constrained by the constraining redo transport mode and automatically shift to the nonconstraining redo transport mode when the database system determines that the current transaction processing rate is being constrained by the constraining redo transport mode and
   that the database system operate in the nonconstraining redo transport mode as long as the database system continues to determine that the current transaction processing rate would be constrained by the constraining redo transport mode and automatically shift to the constraining redo transport mode when the database system determines that the current transaction processing rate would not be constrained by the constraining redo transport mode.

Other objects and advantages will be apparent to those skilled in the arts to which the invention pertains upon perusal of the following Detailed Description and drawing, wherein:

### BRIEF DESCRIPTION OF THE SEVERAL VIEWS OF THE DRAWINGS

FIG. 1 shows a prior art database system that includes a primary and standby databases;

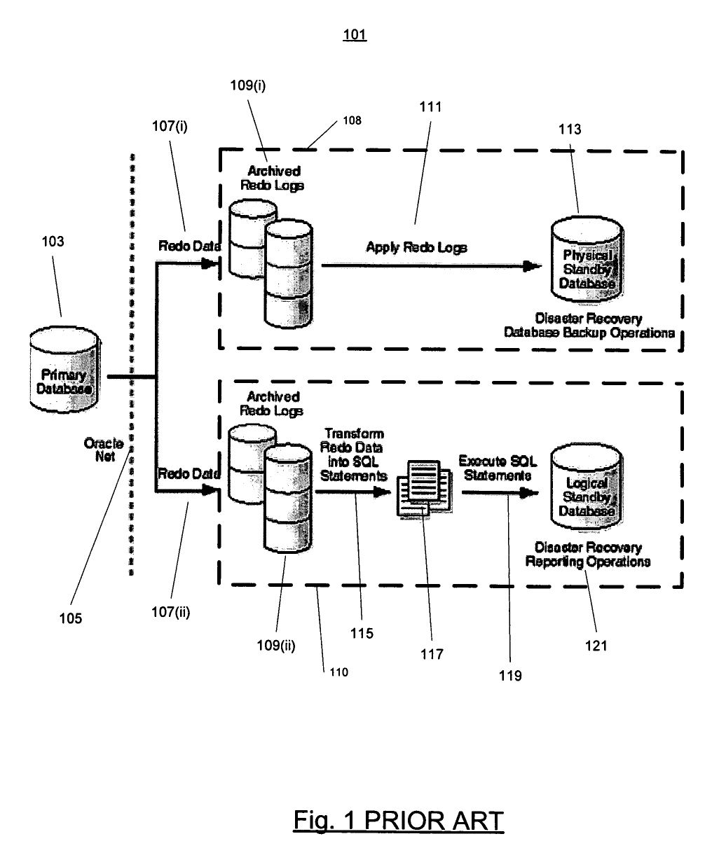

FIG. 2 is a flowchart that provides an overview of the improved technique for automatically changing to a different transport;

FIG. 3 is a flowchart that shows a first improved technique for implementing an automatic change to a different transport;

FIG. 4 is a flowchart that shows a second improved technique of implementing an automatic change to a different transport; and

FIG. 5 is a block diagram of a database system in which the technique of FIG. 4 has been implemented.

### DETAILED DESCRIPTION OF THE INVENTION

The following Detailed Description will first present an overview of an improved technique for automatically changing to a different transport mode, will then present two implementations of the improved maximum availability mode, and will finally present details of how the second implementation is implemented in an Oracle 10gR2 database system manufactured by Oracle Corporation.

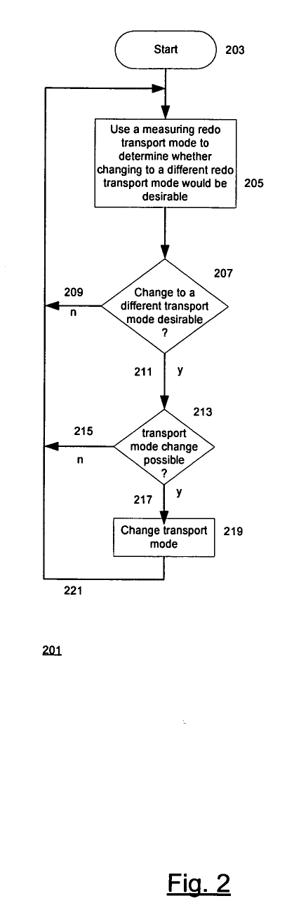

### Overview of the Improved Technique for Automatically Changing to a Different Transport Mode: FIG. 2

FIG. 2 is a flowchart of a technique for automatically changing to a different transport for redo data mode on the basis of the whether a primary's transaction processing rate would be constrained by a transport mode. In the preferred embodiment, the possibly-constraining transport mode is the synchronous transport mode and there is only one other available transport mode, namely the asynchronous transport mode. In other embodiments, there may be other constraining transport modes. The technique of the flowchart of FIG. 2 will work in any situation where transport modes have different degrees by which they may potentially constrain a primary's transaction processing rate.

At the start 203 of the method, the primary database system is already using one of the available transport modes to provide redo to a standby database system. As the primary database system does so, the primary database system periodically executes loop 221. On each execution the primary database system determines whether a redo transport mode would at least potentially constrain the rate at which the primary database system is currently processing transactions. This redo mode will be termed in the following the measuring redo transport mode. In a preferred embodiment, the measuring redo transport mode is a synchronous transport mode; consequently, whether the measuring redo mode would constrain the rate at which the primary database system is currently processing transactions is determined using current network I/O latency currLAT(x) for the measuring redo transport mode (205). This is computed for x bytes of redo data as RTT(x)+IO(x), where RTT is the round trip time to send the x bytes of redo data from the primary database system to the standby database system and receive the confirmation for it in the primary data base system and IO(x) is the time it takes the standby database system to write the x bytes of redo data to the standby's redo log.

The primary database system then uses the value of currLAT(x) for the measuring redo transport mode to determine whether changing to a different transport mode for the redo data would be desirable (207). A change to a different transport mode is desirable if the value indicates that:
the different transport mode has a lower risk of data loss than the present transport mode and will not constrain the primary database system at the primary database system's present rate of processing transactions; or
the different transport mode has a higher risk of data loss than the present transport but will be less constraining to the primary database system than the current transport mode presently is.

If currLAT(x) for the measuring redo transport mode indicates that no change in the transport mode is necessary, the loop is again executed after a wait period (209). Otherwise, branch 211 is taken and the primary database system determines whether a transport mode change is possible (213). If it is not, the loop is again executed as before (215). If so (217), the transport mode is changed to a more desirable transport mode (219). An example of a transport mode change that would be desirable but not possible would be a case where the current network latency would permit a change from an asynchronous to a synchronous transport mode but there is no standby database system currently available. In the preferred embodiment, there are only two transport modes and consequently, the method of flowchart 201 selects one or the other of these transport modes based on the current network latency for the SYNCH transport. In other embodiments, there may be more than two transports.

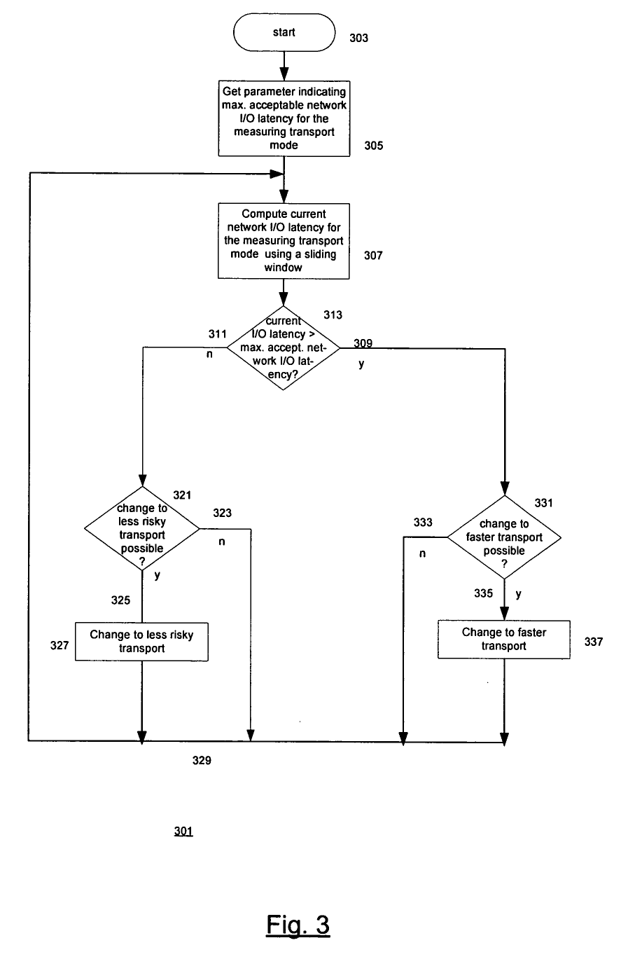

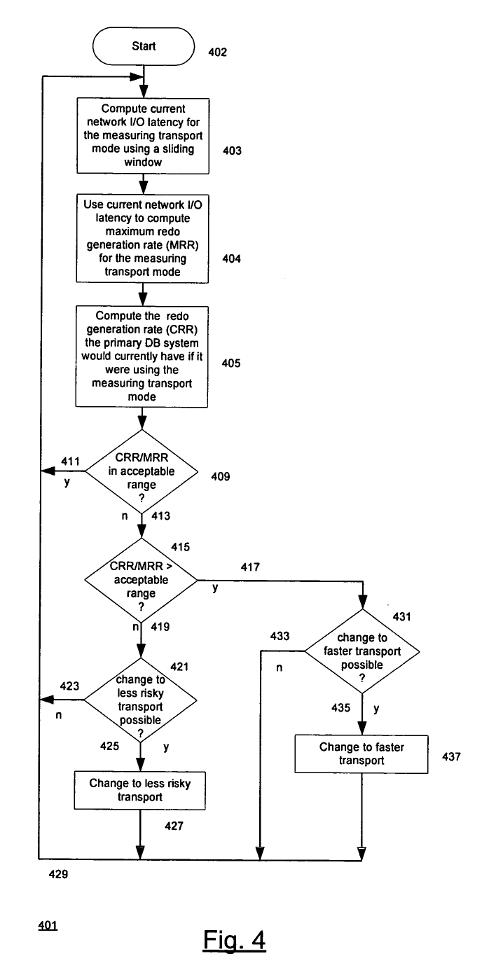

### Techniques for Determining Whether a Transport Change is Desirable: FIGS. 3 and 4

In the following, two techniques are described for determining whether a transport change is desirable. The first of these makes the determination on the basis of a parameter received from the database administrator which indicates a range of acceptable current network I/O latencies for the measuring transport mode. The second makes the determination on the basis of how much of the measuring transport mode's currently available bandwidth the primary would require at the primary's current rate of generating redo data. As described, the techniques are used with two transport modes; they may, however, be easily adapted to systems with more than two transport modes.

### Using a Maximum Acceptable Network I/O Latency Parameter: FIG. 3

FIG. 3 is a flowchart 301 of the first technique. The method begins at 303; at 305, the database administrator provides a parameter indicating a maximum acceptable network I/O latency for the measuring transport mode. Then the periodic execution of loop 329 begins. The first step in the loop is to compute the current network I/O latency for the measuring transport mode (synchronous mode in the preferred embodiment) (307). In the preferred embodiment, this is done using a moving average over a sliding time window in order to smooth the rate of change. The current network I/O latency for the measuring transport mode is the average network I/O latency for that mode for a predetermined period of time which extends back from the present.

If the current network I/O latency for the measuring transport mode is larger than the maximum acceptable I/O latency (313), indicating that the measuring transport mode would constrain the primary database system, the primary database system determines whether a change to a faster transport mode is possible (309, 331). If it is (335), the change is made (337) and the loop is repeated; if not, the loop is simply repeated (333). If the current network I/O latency for the measuring transport mode is not greater than the maximum acceptable I/O latency, (311), the primary database system determines whether a change to a less risky transport mode is possible (321); if it is (325), the change is made (327) and the loop is repeated; if not, the loop is simply repeated (323). In embodiments with more than two kinds of transport modes for redo data, there could be a maximum acceptable I/O latency for each transport mode.

### Determining how Much of the Measuring Transport Mode's Bandwidth is Currently Being Used: FIG. 4

The scheme of FIG. 3 is simple and easy to implement, but it has several disadvantages. One is that it is left to the user to figure out what the maximum acceptable network latency is. A more important disadvantage is that the scheme does not take into account the rate at which the primary is actually generating redo while using the current transport mode. The primary's actual redo generation rate is, however, essential for determining whether there is a transport mode available that is less risky than the current transport mode and still will not constrain the primary at the primary's current rate of redo generation.

FIG. 4 is a flowchart 401 of a version of the technique in which the primary's current rate of redo generation is taken into account in determining whether there should be a change in the transport used. Beginning at 402, there is no longer any need to obtain the maximum acceptable network I/O latency from the DBA. The first step in loop 429 is to compute the current network I/O latency for the measuring transport mode (403). This computation has already been described for the synchronous transport mode. As described there, it is done using a moving average over a sliding time window. Next, the current network I/O latency is used to compute the maximum rate at which the primary may generate redo for the measuring transport mode (404). This rate is termed in the following the Maximum Redo Rate or MRR, expressed as bytes per second. MRR(x) is computed as follows: MRR(x)=(1 second/currLAT(x))(avg. packet size), where x is the average size of a packet of redo data. The average packet size is also maintained as a moving average over a sliding time window. Then the current actual redo generation rate for the measuring transport mode, CRR(x), is computed for the window. CRR(x), also expressed in bytes per second, is the rate at which the primary would have actually generated redo data if it had been using the measuring transport mode. CRR(x) is determined from the amount of data that the primary actually writes to its redo log during the current sliding window. The total amount written during the sliding window is divided by the period in seconds of the sliding window (405) in order to arrive at a value expressed in terms of bytes per second.

Then, at 409, whether a change in transport is desirable is determined from the value of the expression CRR(x)/MRR(x) (409). The larger this fraction is, the more likely it is that the speed of the measuring transport mode may constrain the primary database system; the smaller it is, the less likely. The decision whether to change the transport mode is made by establishing an upper bound and a lower bound for the value of the fraction. If CRR(x)/MRR(x) is greater than the upper bound, the measuring transport mode is taken to be constraining the primary database system; if it is less than the lower bound, the measuring transport mode is taken to be not constraining the primary database system. Consequently, in a preferred embodiment, if the fraction is above the upper bound, the transport should be changed to a faster transport if the current transport mode is the measuring transport mode; if it is below the lower bound, the transport should be changed to a less risky transport mode if the current transport mode is more risky. The logic for changing transport modes at 413-437 is identical with the logic of FIG. 3. In a preferred embodiment, the upper bound for the fraction's value is around 0.85 and the lower bound is around 0.70. In some embodiments, the upper and lower bounds may be parameters provided by the DBA. In embodiments in which more than two kinds of transport modes are available, an upper and lower bound can be provided for each of the transport modes. In embodiments with more than one redo transport mode that can potentially constrain the primary database system, each of the constraining transport modes may be used as a measuring transport mode or only one may be used, with the decision whether to switch to another constraining transport mode being made using the single measuring transport mode.

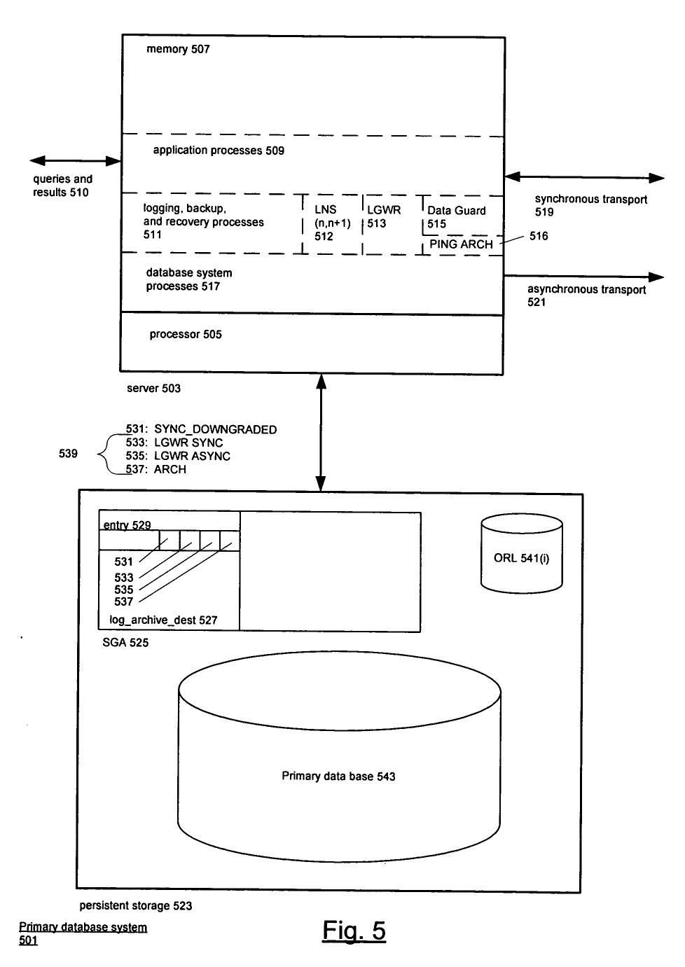

### Implementing the Scheme of FIG. 4 in an Oracle 10gR2 Database System: FIG. 5

### Overview of Relevant Components of a Primary Database System that is an Oracle 10gR2 Database System

FIG. 5 is a high level block diagram of an Oracle 10gR2 database system showing components of the system that are relevant to the present discussion. Shown in FIG. 5 is a primary database system 501, but in the areas of present interest, a standby database system is substantially identical. The two major components of database system 501 are server 503 and persistent storage 523, which contains primary database 543. Server 503 processes queries and transactions that generate redo data from clients of database system 501 and ships that redo data to one or more standby systems via synchronous transport 519 and asynchronous transport 521. Server 503 has a processor 505 and a memory 507 that contains data and programs for a number of processes being executed by processor 505. The processes include application processes 509, which handle the queries received from the clients, logging, backup, and recovery processes 511, which manage logging, backup to a standby database system, and recovery of a failed database system, and database system processes, which execute queries on primary database 543 and maintain primary database 543.

Persistent storage 523 is storage such as disk drives which do not lose their data when powered down. In addition to primary database 543, persistent storage 523 includes system global area (SGA) 525, which contains data that is available to all of the processes that execute in server 503 and a number of on-line redo logs (ORL) 541(0 . . . n), one of which, ORL 541(i), is shown.

Components of system 501 which are of particular interest in the present context include certain processes of logging, backup and recovery processes 511, the data structure log_archive_dest 527 in SGA 525, and the current ORL 541. Beginning with the current ORL 541, current ORL 541 contains the most recent redo data generated by server 503. The redo data is written to current ORL 541 a buffer at a time. The next buffer to be written to current ORL 541 is termed in the following the current buffer. When system 501 is employing a synchronous transport to send redo data to the standby database system, the packets of redo data sent to the standby database system are copies of the blocks of redo contained in the current buffer and are sent to the standby database system immediately after the current buffer is written to current ORL 541. The next current buffer of redo is not written to current ORL 541, nor is acknowledgement of the write of the current buffer made to the generating application, until confirmation is received that the packet of redo sent to the standby database system has been written to the standby database system's redo log. The use of synchronous transport thus guarantees that the redo log in the standby contains an exact copy of the redo data written to the current ORL 541.

The first logging, backup, and recovery processes that is of interest is LGWR process 513, which writes buffers of redo data to the current ORL 541. The second set of processes that are of interest are LNS processes 512, which send packets of data across the network to the standby database systems. A LNS process may employ either the synchronous or asynchronous transport modes. In the case of the synchronous transport mode, the LNS process receives packets of redo data from the LGWR process after the redo data in the packets has been written to the current ORL 541 and sends each packet in turn to the standby, waiting until it has received the confirmation from the standby before signaling the LGWR to continue. When using the asynchronous transport mode, the LNS process simply reads blocks of data from the current ORL 541 and sends them by the fastest mode to the standby database system; there is no direct interaction with the LGWR process.

Data Guard processes 515, finally, is a set of processes that establishes a relationship between a primary database system and one or more standby database systems and then manages the relationship. A Data Guard operation which is important in the current context is changing the transport mode used by a primary database to transfer redo data to a standby database system without stopping and restarting either the primary database system or the standby database system. An important component process of data guard processes 515 is PING ARCH process 516, which periodically pings a primary database system's standby database systems to determine whether the standby is missing any redo generated by the primary. The pinging period for PING ARCH when it is used in this fashion is 1 minute.

The data structure log_archive_dest 527 in SGA 525, finally, contains an entry 529 for every database system which the data guard processes 515 have configured as a standby database system for the primary database system. The part of the entry which is of interest in the present context is a set of flags 539 which indicate the kind of transport mode being used to transport redo data to the standby database system represented by the entry:
LGWR SYNC 533 indicates that LGWR processes 513 and LNS processes 512 are cooperating to send redo data to the standby using the synchronous transport mode;
LGWR ASYNC 535 indicates that LNS process 512 is sending redo data to the standby independently of LGWR 513 using the asynchronous transport mode, i.e., it is reading the data from the current ORL 541(i) and sending it asynchronously;

ARCH 537 indicates that there is no connection between LGWR writing data to an ORL 541(i) and the reading of redo data from an archival redo log in primary database system to the standby. The transport mode specified by ARCH is used to send a copy of a non-current ORL 541 to the standby when the PING ARC detects a gap in the redo. Examples of situations which produce gaps in the redo data are if the standby has been down for a while or if logs got deleted before they were applied.

### Modifying Data Guard 515, PING ARCH 516, and log_archive_dest 527 to Implement the Scheme of FIG. 4

There are four parts to modifying an Oracle 10gR2 database system to implement the scheme of FIG. 4:
collecting the statistics necessary to make a change in the transport;
determining whether a change should be made;
making the change; and
indicating that the change has been automatically made.

All of the above are implemented by adding a new flag 531, SYNC_DOWNGRADED, to entry 529 and modifying PING ARCH 516. PING ARCH 516 now pings the standby every 10 seconds. PING ARCH 516 can of course determine the current network round trip time from its own pings and PING ARCH 516 is able to simply use the size of the buffers that LGWR 513 writes to the current ORL 541 to determine the average size of the packets written to the standby. The time it takes the standby database system to write a packet of data to the redo log is known from statistics maintained by the database system, and consequently, PING ARCH 516 can do the following every 10 seconds: collect the necessary statistics to compute MRR and CRR, average them using the sliding window, compute CRR(x)/MRR(x), and change the transport whenever CRR(x)/MRR(x) so indicates according to the current transport mode. When downgrading the SYNC transport to ASYNC for a particular standby database when CRR(x)/MRR(x) exceeds the upper bound percentage, PING ARCH 516 sets the SYNC_DOWNGRADED bit in the log_archive_dest_N structure corresponding to that destination then requests a log switch (a change to a new ORL 541) which will effect the change. Any SYNC destination with the SYNC_DOWNGRADED bit set will be treated internally as an ASYNC destination. When CRR(x)/MRR(x) drops below the lower bound percentage, PING ARCH 516 clears the corresponding SYNC_DOWNGRADED bit and again requests a log switch to effect the change.

In the preferred embodiment, MRR(x) always represents the maximum rate at which redo can be currently produced in synchronous mode. When the primary is operating in asynchronous mode, MRR(x) is computed from the writes which the primary makes to ORL 541 in this mode. The buffers which the primary writes to ORL 541 while it is operating in asynchronous mode are much smaller than those which it writes to ORL 541 in synchronous mode. The difference in buffer size must be taken account of by means of a scaling factor when MRR(x) is computed while the primary is operating in asynchronous mode.

### CONCLUSION

The foregoing Detailed Description has disclosed to those skilled in the relevant technologies the inventors' techniques for automatically changing a database system's redo transport mode to dynamically adapt to changing workload and network conditions and has further disclosed the best mode known to the inventors of practicing their techniques. It will, however, be immediately apparent to those skilled in the relevant technologies that many implementations of the techniques other than the ones disclosed herein are possible. To begin with, the preferred embodiments are implemented in database systems manufactured by Oracle Corporation and employ the transport modes available in Oracle database systems, take advantage of the instrumentation available in Oracle database systems to determine whether a change of transport mode is desirable, and use the state available in the Oracle database systems to change the transport mode where necessary. Implementations in other database systems would similarly employ the transport modes, instrumentation, and state available in those database systems. Further, the preferred embodiment employs the techniques to switch between a transport mode that can potentially constrain the primary database system and one that cannot; the techniques can, however, be used to switch between transport modes for any reason at all. For example, a measuring transport mode could be used to determine whether a switch in transport modes based purely on risk of redo loss was desirable, or if the cost of a transport mode were an issue, a measuring transport mode could be used to determine whether a switch in transport modes based on cost was desirable.

Further, there are only two transport modes in a preferred embodiment; the techniques, however, can be employed to select among any number of transport modes. The techniques used to determine whether a current redo transport mode should be changed will of course depend not only on the database system in which the techniques are implemented, but also on the basis for switching transport modes. For all of the foregoing reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

1. A method that is employed in a database system having a primary database system in which redo is produced and a standby database system to which the redo may be transported by a plurality of redo transport modes, the method automatically changing the redo transport mode and comprising the steps of:
making a determination whether a current redo transport mode of the plurality should be changed using a measuring redo transport mode of the plurality;
if the determination so indicates, automatically switching to another redo transport mode of the plurality.

2. The method set forth in claim 1 wherein:
in the step of making a determination, a rate at which the primary database system is currently producing redo is taken into account.

3. The method set forth in claim 1 wherein:
in the step of making a determination, a current condition of a network by which the redo is transported is taken into account.

4. The method set forth in claim 1 wherein:
in the step of making the determination, both a rate at which the primary database system is currently producing redo and a current condition of a network by which the redo is transported is taken into account.

5. The method set forth in claim 3 wherein
the database system has a network I/O latency which is a period between the time a packet of redo is sent to the standby and the time a confirmation for the packet is received from the standby; and
the step of determining includes the steps of:
determining a current network I/O latency for the measuring redo transport mode and
using the current network I/O latency to determine whether the current redo transport mode should be changed.

6. The method set forth in claim 5 wherein
the step of using the current network I/O latency includes the step of:
comparing the current network I/O latency with a value that specifies a maximum acceptable network I/O latency, the redo transport mode being changed if the current network I/O latency is greater than the maximum acceptable network I/O latency.

7. The method set forth in claim 6 wherein:
the current network I/O latency is the average network I/O latency in a sliding window.

8. The method set forth in claim 4 wherein
the database system has a network I/O latency which is a period between the time a packet of redo is sent to the standby and the time a confirmation for the packet is received from the standby and
the step of making the determination includes the steps of:
determining a rate at which the primary database system is currently actually generating redo (CRR);
determining a current network I/O latency for the measuring redo transport mode;
determining a maximum rate at which the primary database system can generate redo using the current network I/O latency (MRR); and
using CRR and MRR to determine whether the current redo transport mode should be changed.

9. The method set forth in claim 8 wherein:
the step of using CRR and MRR employs bounds on a ratio made using CRR and MRR to determine whether the redo transport mode currently being used should be changed.

10. The method set forth in claim 9 wherein:
CRR and MRR are computed on the basis of a sliding window.

11. The method set forth in claim 1 wherein:
the redo transport modes include a constraining redo transport mode that may constrain a current transaction processing rate for the primary database system and a non-constraining redo transport mode that cannot constrain the current transaction rate;
in the step of making the determination, the measuring redo transport mode is used to determine whether the constraining redo transport mode would constrain the current transaction processing rate; and
in the step of automatically switching,
if the step of making a determination determines that the constraining transport mode would constrain the current transaction processing rate and the current transport mode is the constraining transport mode, the transport mode is automatically switched to the nonconstraining transport mode and
if the step of making a determination determines that the constraining transport mode would not constrain the current transaction process rate and the current transport mode is the non-constraining transport mode, the transport mode is automatically switched to the constraining transport mode.

12. The method set forth in claim 11 wherein:
the constraining transport mode is a synchronous transport mode which can constrain a current transaction processing rate but has a lower probability of data loss; and
the nonconstraining transport mode is an asynchronous transport mode which does not constrain the current transaction processing rate but has a higher probability of data loss.

13. A data storage device, the data storage device being characterized in that:
the data storage device contains code which, when executed, causes a database system to perform the method set forth in claim 1.

14. Apparatus employed in a database system having a primary database system in which redo is produced and a standby database system to which the redo may be transported by a plurality of redo transport modes, the apparatus automatically changing the redo transport mode and comprising:
a redo transport mode analyzer that uses a measuring redo transport mode of the plurality to make a determination of whether a current redo transport mode of the plurality should be changed; and
a mode switcher that responds when the determination so indicates by automatically switching to another redo transport mode of the plurality.

15. The apparatus set forth in claim 14 wherein:
in making the determination, the redo transport mode analyzer takes a rate at which the primary database system is currently producing redo into account.

16. The apparatus set forth in claim 14 wherein:
in making the determination, the redo transport mode analyzer takes a current condition of a network by which the redo is transported into account.

17. The apparatus set forth in claim 14 wherein:
in making the determination, the redo transport mode analyzer takes both a rate at which the primary database system is currently producing redo and a current condition of a network by which the redo is transported into account.

18. The apparatus set forth in claim 16 wherein
the database system has a network I/O latency which is a period between the time a packet of redo is sent to the standby and the time a confirmation for the packet is received from the standby; and
in making the determination, the redo transport mode analyzer determines a current network I/O latency for the measuring redo transport mode and uses the current network I/O latency to determine whether the current redo transport mode should be changed.

19. The apparatus set forth in claim 18 wherein
the redo transport mode analyzer uses the current network I/O latency to determine whether the redo transport mode currently being used is constraining the current redo production rate by comparing the current network I/O latency with a value that specifies a maximum acceptable network I/O latency and indicating that the redo transport mode be changed if the current network I/O latency is greater than the maximum acceptable network I/O latency.

20. The apparatus set forth in claim 19 wherein:
the current network I/O latency is the average network I/O latency in a sliding window.

21. The apparatus set forth in claim 17 wherein
the database system has a network I/O latency which is a period between the time a packet of redo is sent to the standby and the time a confirmation for the packet is received from the standby and
the redo transport mode analyzer determines whether the redo transport mode is to be changed by
determining a rate at which the primary database system is currently actually generating redo (CRR);
determining a current network I/O latency;
determining a maximum rate at which the primary database system can generate redo using the current network I/O latency (MRR); and
using CRR and MRR to determine whether the current redo transport mode is to be changed.

22. The apparatus set forth in claim 21 wherein:
In using the CRR and the MRR, the redo transport mode analyzer employs bounds on a ratio made using CRR and MRR to determine whether the current redo transport mode currently being used is to be changed.

23. The apparatus set forth in claim 22 wherein:
CRR and MRR are computed on the basis of a sliding window.

24. The apparatus set forth in claim 14 wherein:
the redo transport modes include a constraining redo transport mode that may constrain a current transaction processing rate for the primary database system and a non-constraining redo transport mode that cannot constrain the current transaction rate;
in making the determination, the redo transport mode analyzer uses the measuring redo transport mode to determine whether the constraining redo transport mode would constrain the current transaction processing rate;
if the redo transport mode analyzer determines that the constraining transport mode would constrain the current transaction processing rate and the current transport mode is the constraining transport mode, the transport mode switcher automatically switches to the nonconstraining transport mode and
if the redo transport mode analyzer determines that the constraining transport mode would not constrain the current transaction process rate and the current transport mode is the non-constraining transport mode, the transport mode switcher automatically switches to the constraining transport mode.

25. The apparatus set forth in claim 24 wherein:
the constraining transport mode is a synchronous transport mode which can constrain a current transaction processing rate but has a lower probability of data loss; and
the nonconstraining transport mode is an asynchronous transport mode which does not constrain the current transaction processing rate but has a higher probability of data loss.

26. A data storage device, the data storage device being characterized in that:
the data storage device contains code which, when executed, causes a database system to implement the apparatus set forth in claim 14.

27. A method that is employed in a database system having a primary database system in which redo is produced and a standby database system to which the redo may be transported by a plurality of redo transport modes, the plurality of redo transport modes including a constraining redo transport mode that potentially constrains the rate at which the primary database system processes transactions and a nonconstraining redo transport mode that does not constrain the rate at which the primary database system processes transactions,
the method automatically changing the redo transport mode and comprising the steps of:
making a determination whether the constraining redo transport mode would constrain a current transaction processing rate of the primary database system; and
if the determination so indicates and the current redo transport mode is the constraining redo transport mode, switching to the nonconstraining redo transport mode; and
if the determination does not so indicate and the current redo transport mode is the nonconstraining redo transport mode, switching to the constraining redo transport mode.

28. The method set forth in claim 27 wherein:
the constraining redo transport mode has a lower risk of redo loss than the nonconstraining redo transport mode.

29. A data storage device, the data storage device being characterized in that:
the data storage device contains code which, when executed, causes a database system to perform the method set forth in claim 27.

30. Apparatus employed in a database system having a primary database system in which redo is produced and a standby database system to which the redo may be transported by a plurality of redo transport modes, the plurality of redo transport modes including a constraining redo transport mode that potentially constrains the rate at which the primary database system processes transactions and a nonconstraining redo transport mode that does not constrain the rate at which the primary database system processes transactions,
the apparatus automatically changing the redo transport mode and comprising:
a redo transport mode analyzer that makes a determination whether the constraining redo transport mode would constrain a current transaction processing rate of the primary database system; and
a mode switcher that responds when the determination so indicates and the current redo transport mode is the constraining redo transport mode by automatically switching to the nonconstraining redo transport mode and responds when the determination does not so indicate and the current redo transport mode is the nonconstraining redo transport mode by automatically switching to the constraining redo transport mode.

31. The apparatus set forth in claim 30 wherein:
the constraining redo transport mode has a lower risk of redo loss than the nonconstraining redo transport mode.

32. A data storage device, the data storage device being characterized in that:
the data storage device contains code which, when executed, causes a database system to implement the apparatus set forth in claim 30.

33. A database system having a primary database system in which redo is produced and a standby database system to which the redo may be transported by a plurality of redo transport modes, the plurality of redo transport modes including a constraining redo transport mode that potentially constrains the rate at which the primary database system processes transactions but has a lower risk of loss of redo and a nonconstraining redo transport mode that does not constrain the rate at which the primary database system processes transactions but has a higher risk of loss of redo, the database system being characterized in that:
the database system includes user-settable state that permits a user to specify which redo transport mode is to be used in the database system, the user-settable state specifying in the alternative
that the database system operate only in the constraining redo transport mode;
that the database system operate only in the nonconstraining redo transport mode; and
that the database system operate in the constraining redo transport mode as long as the database system continues to determine that a current transaction processing rate at which the primary database system is currently processing transactions is not being constrained by the constraining redo transport mode and automatically shift to the nonconstraining redo transport mode when the database system determines that the current transaction processing rate is being constrained by the constraining redo transport mode and
that the database system operate in the nonconstraining redo transport mode as long as the database system continues to determine that the current transaction processing rate would be constrained by the constraining redo transport mode and automatically shift to the constraining redo transport mode when the database system determines that the current transaction processing rate would not be constrained by the constraining redo transport mode.
